(19) United States
(12) Patent Application Publication
(10) Pub. No.: US 2008/0060921 A1
(43) Pub. Date: Mar. 13, 2008

(54) KEYPAD FOR AN ELECTRONIC DEVICE

(75) Inventors: Ami Isakov, Kfar-Saba (IL); Jacob Nainudel, Rishon Letzion (IL); Ariel Rotman, Ramat Efal (IL); Timothy J. Sweeney, Austin, TX (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/530,920

(22) Filed: Sep. 12, 2006

(51) Int. Cl. H01H 9/00

(52) U.S. Cl. 200/314

(57) ABSTRACT

A keypad (200) including one or more keys and an illumination system (300) is provided. The one or more keys, such as a key (212), have a transparent side element (306). The light from the illumination system can be transferred to an opaque housing (202), adjacent to each of the one or more keys, through the transparent side element. Further, the illumination system illuminates one or more symbols, such as a symbol (302), located on the one or more keys and a symbol (304) on the opaque housing.

### FIELD OF THE INVENTION

This invention generally relates to electronic devices, and more particularly, to a keypad used in an electronic device.

### BACKGROUND OF THE INVENTION

The growing demand for electronic communication and computing has resulted in the frequent use of electronic devices in our day-to-day lives. Examples of electronic devices include personal computers (PCs), mobile telephones, laptop computers, Personal Digital Assistants (PDAs), facsimile machines, and remote control devices. To operate an electronic device, a user can provide an input by using a user interface. Examples of user interfaces include a button switch, a mouse, a touch screen, and a keypad.

A keypad of an electronic device typically includes multiple keys. Each key may have one or more symbols, where each symbol is associated with a particular function of the electronic device. For example, the symbol ‘#’ on the key of a mobile device may be associated with opening a menu. Symbols are usually printed on top of the keys of the keypad. A user can press a key on the keypad to activate the function associated with the symbol. For an electronic device with a large number of functions, the number of symbols required to identify the functions may be more than the number of keys available on the keypad. These symbols can be placed on an opaque housing next to a key on the keypad. A symbol printed on the opaque housing may not be visible to a user when the keypad is operated in low light or in dark conditions. Hence, there is a need to enable the user to see the symbols printed on the opaque housing in the above-mentioned conditions.

Many prior art methods exist for illuminating the keys and the opaque housing of a keypad. One of these methods uses a front light to illuminate the opaque housing and the keys. However, the front light illumination technique provides a non-uniform distribution of light intensity on the surface of the keypad. Hence, the keys near the front light receive more light than the keys that are further away. Additionally, this technique does not provide individual illumination of symbols but illuminates only the surface of the keypad.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an example of an electronic device, in accordance with some exemplary embodiments of the present invention.

FIG. 2 illustrates an example of a keypad, in accordance with an exemplary embodiment of the present invention.

FIG. 3 illustrates an example of a key on the keypad being illuminated by an illumination system, in accordance with an exemplary embodiment of the present invention.

FIG. 4 illustrates an example of an illumination system for the keypad, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve an understanding of embodiments of the present invention.

### DETAILED DESCRIPTION

In an embodiment of the present invention, a keypad is disclosed. The keypad includes one or more keys and an illumination system. The one or more keys have a transparent side element. The illumination system illuminates one or more symbols located on the one or more keys and on the opaque housing. The light from the illumination system can be transferred to an opaque housing, adjacent to each of the one or more keys, through the transparent side element.

In another embodiment of the present invention, an electronic device is disclosed. The electronic device includes a keypad and an illumination system. The keypad has one or more keys with a transparent side element. The illumination system illuminates one or more symbols located on each of the one or more keys and on the opaque housing. The light from the illumination system is transferred to an opaque housing, which is adjacent to each of the one or more keys, through the transparent side element.

Before describing in detail a keypad for an electronic device, in accordance with various embodiments of the present invention, it should be observed that the present invention resides primarily in combinations of apparatus components related to a keypad used in an electronic device. Accordingly, the apparatus components have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having,” as used herein, are defined as comprising.

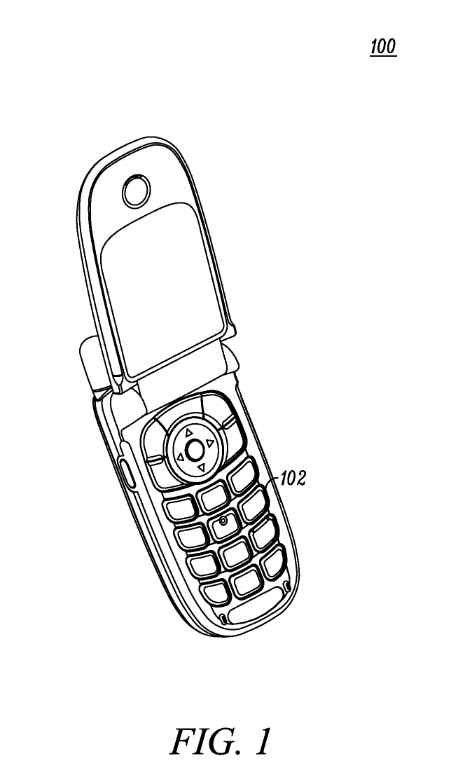

FIG. 1 illustrates an example of an electronic device 100, in accordance with some exemplary embodiments of the present invention. Apart from other essential components, the electronic device 100 includes a user interface 102 such as a keypad and an illumination system (not shown in FIG. 1). The keypad includes one or more keys with a transparent side element. Further the illumination system illuminates one or more symbols located on each of the one or more keys, as well as on an opaque housing adjacent to each of the one or more keys. The light from the illumination system is transferred to the opaque housing through the transparent side element. Examples of the electronic device 100 include, but are not limited to, personal computers (PCs), mobile telephones, laptop computers, Personal Digital Assistants (PDAs), facsimile machines, and remote control devices. Further, the user interface 102, for example a keypad, is operatively coupled with the electronic device 100. A user can operate the electronic devices 100 by using the user interface 102, just as a user can operate a mobile phone by inputting numerals on a keypad to make a call.

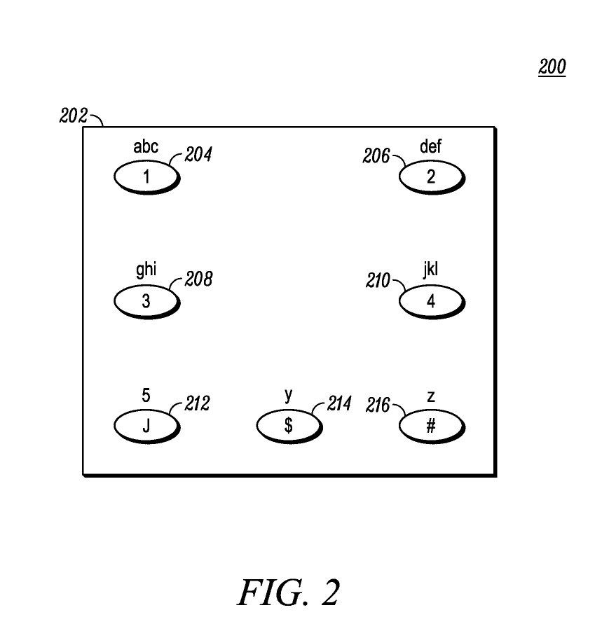

FIG. 2 illustrates an example of a keypad 200, in accordance with an exemplary embodiment of the present invention. The keypad 200 includes an opaque housing 202 and one or more keys such as a key 204, a key 206, a key 208, a key 210, a key 212, a key 214, and a key 216. In an embodiment, the one or more keys are plugged into apertures in the opaque housing 202. Further, each of the one or more keys has one or more symbols located on top of it, and one or more symbols located on top of the opaque housing 202 adjacent to it. In an embodiment of the present invention, the one or more symbols located on top of a key are printed on the key. In another embodiment of the present invention, the one or more symbols located on top of the opaque housing 202 adjacent to a key are printed on the opaque housing 202. For example, the key 212 has a symbol ‘J’ located on top of it and a symbol ‘5’ located on top of the opaque housing 202 next to the key 212. The printing on the opaque housing 202 and the top of the one or more keys can be of a transparent or a translucent material.

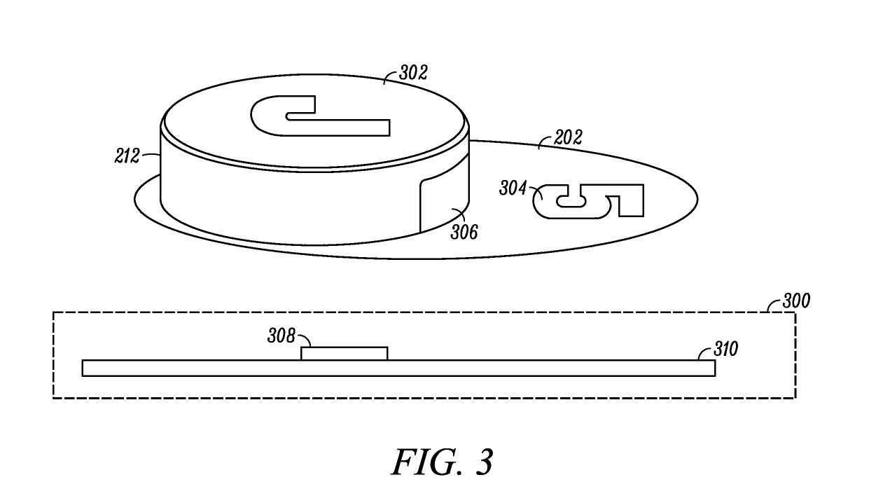

FIG. 3 illustrates an example of a key 212 on the keypad 200 being illuminated by an illumination system 300, in accordance with an exemplary embodiment of the present invention. The key 212 can be used to activate more than one function in the electronic device 100, such as dialing a number and scrolling a menu in a mobile device. These two functions are represented by a symbol 302 and a symbol 304. The symbol 302 is located on top of the key 212, and the symbol 304 is located on top of the opaque housing 202 adjacent to the key 212. Further, the key 212 includes a transparent side element 306. The transparent side element 306, which is made of material that is transparent to light, is used to transfer light to the symbol 304. Examples of materials used to manufacture the transparent side element 306 include, but are not limited to, glass, transparent plastic and transparent rubber.

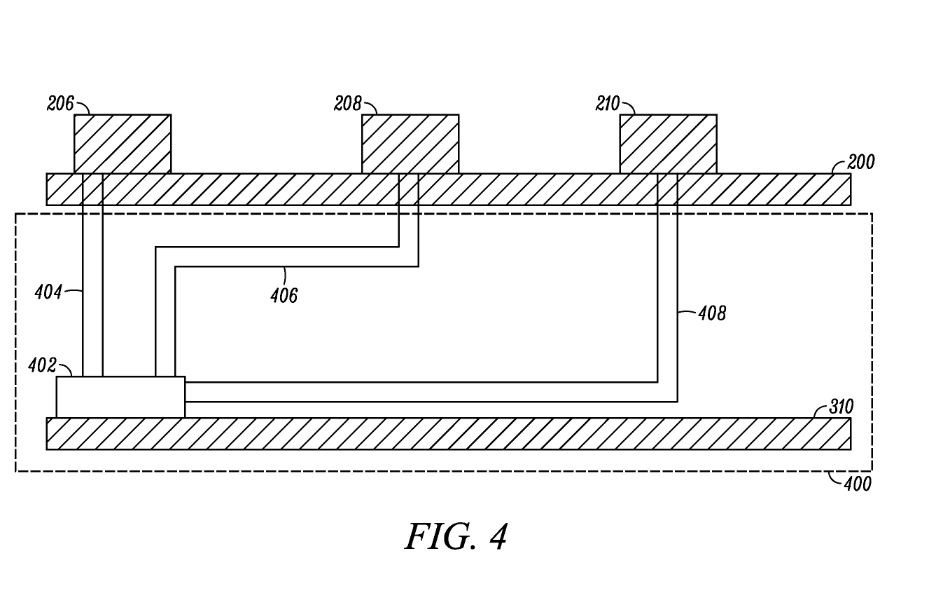

In accordance with an embodiment of the present invention, the illumination system 300 includes a light source 308 and a circuit board 310. The light source 308 is positioned under the key 212 and is used to illuminate the symbols located on the key 212 as well as on the opaque housing 202 adjacent to the key. In accordance with another embodiment, light from the light source 308 can be channeled by using light pipes on the key 212 and on the opaque housing 202 adjacent to the key. This is explained in detail in conjunction with FIG. 4. Examples of the light source 308 include, but are not limited to, light-emitting diodes, laser diodes, electro-luminescent lamps, and radio-luminescent lamps. Further, the light source 308 projects light on to the key 212, illuminating the symbol 302. This light is transferred to the symbol 304 through the transparent side element 306, can illuminate the symbol 304.

In accordance with an embodiment, the circuit board 310 can be a part of a circuitry of the electronic device 100. The light source 308 is housed in the circuit board 310. The circuit board 310 can be electronically coupled to the light source 308 and includes the circuitry for activating the light source 308. In an embodiment of the present invention, each of the one or more keys of the keypad 200 can have a corresponding light source for illuminating symbols on top of the key and on the corresponding opaque housing. These light sources are housed in a circuit board positioned under the keys of the keypad 200.

FIG. 4 illustrates an example of an illumination system 400 for the keypad 200, in accordance with another embodiment of the present invention. The illumination system 400 includes a light source 402, and multiple light pipes such as a light pipe 404, a light pipe 406 and a light pipe 408. These light pipes 404, 406 and 408 are connected to keys 206, 208 and 210. In accordance with an embodiment, light pipes are made of optical fibers, clear polycarbonate, and acrylic. The illumination system 400 also includes the circuit board 310 that is electronically coupled to the light source 308. The light source 402 is positioned under the keys of the keypad 200 and is used to illuminate the symbols located on the keys of the keypad 200 and on the corresponding opaque housings adjacent to the keys of the keypad 200. For clarity, only the keys 206, 208 and 210 of the keypad 200 are shown in FIG. 4. In accordance with an embodiment, the circuit board 310 includes the circuitry for activating the light source 308. The light from the light source 308 is channeled through the light pipes 404, 406 and 408 to illuminate the symbols located on the keys 206, 208 and 210 as well as the symbols located on the opaque housing 202 corresponding to these keys. In accordance with another embodiment, the illumination system 400 can include multiple light sources for illuminating multiple keys on the keypad 200. For example, light from nine light sources can be channeled by nine separate light pipes to illuminate nine keys.

In accordance with various embodiments of the present invention, uniform illumination is provided for a keypad of an electronic device. The symbols on the keys of the keypad receive uniform illumination, which makes it convenient for a user to distinguish the symbols in the dark. Further, light on the symbols on the opaque housing of the keypad enables the user to operate the keypad with multiple function keys, and conveniently access functions on his/her mobile phone in the dark.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required, essential features or elements of any or all the claims. The invention is defined solely by the appended claims, including any amendments made during the pendency of this application, and all equivalents of those claims, as issued.

We claim:

1. A keypad comprising:
one or more keys having a transparent side element; and
an illumination system for illuminating one or more symbols located on the one or more keys and on an opaque housing adjacent to each of the one or more keys, wherein light from the illumination system is transferred to the opaque housing through the transparent side element.

2. The keypad of claim 1, wherein the transparent side element is comprised of a material selected from a group comprising glass, transparent plastic, and rubber material.

3. The keypad of claim 1, wherein the illumination system comprises one or more light sources for illuminating the one or more symbols.

4. The keypad of claim 3, wherein the one or more light sources is positioned directly underneath the one or more keys.

5. The keypad of claim 3, wherein the one or more light sources is connected to one or more light pipes, the one or more light pipes channeling the light onto the one or more keys.

6. The keypad of claim 3, wherein the illumination system further comprises a circuit board, the circuit board being electronically coupled to the one or more light sources.

7. The keypad of claim 3, wherein the one or more light sources is selected from a group comprising light emitting diodes, laser diodes, electro-luminescent lamps and radio-luminescent lamps.

8. The keypad of claim 3, wherein each key of the one or more keys is illuminated using a corresponding light source from the one or more light sources, wherein the light source is positioned directly underneath the each key.

9. The keypad of claim 3, wherein a key of the one or more keys is illuminated using a light source from the one or more light sources, wherein the light source is connected to a light pipe, wherein the light pipe channels the light onto the key.

10. An electronic device comprising:
a keypad, the keypad comprising one or more keys having a transparent side element; and
an illumination system for illuminating one or more symbols located on each of the one or more keys and on an opaque housing adjacent to each of the one or more keys, wherein light from the illumination system is transferred to the opaque housing through the transparent side element.

11. The electronic device of claim 10, wherein the transparent side element is comprised of a material selected from a group comprising glass, transparent plastic, and rubber material.

12. The electronic device of claim 10, wherein the illumination system comprises one or more light sources for illuminating the one or more symbols.

13. The electronic device of claim 12, wherein the one or more light sources is positioned directly underneath the one or more keys.

14. The electronic device of claim 12, wherein the one or more light sources is connected to one or more light pipes, wherein the one or more light pipes channels the light onto the one or more keys.

15. The electronic device of claim 12, wherein the illumination system further comprises a circuit board, the circuit board being electronically coupled to the one or more light sources.

16. The electronic device of claim 12, wherein the one or more light sources is selected from a group comprising light emitting diodes, laser diodes, electro-luminescent lamps and radio-luminescent lamps.

17. The electronic device of claim 12, wherein each key of the one or more keys is illuminated using a light source from the one or more light sources, wherein the light source is positioned directly underneath the each key.

18. The electronic device of claim 12, wherein a key from the one or more keys is illuminated using a light source from the one or more light sources, wherein the light source is connected to a light pipe, wherein the light pipe channels the light onto the key.
